(19) United States
(12) Patent Application Publication
(10) Pub. No.: US 2025/0251031 A1
(43) Pub. Date: Aug. 7, 2025

(54) SYSTEM WITH VARIABLE STIFFNESS

(71) Applicant: BOGAZICI UNIVERSITESI, Istanbul (TR)

(72) Inventors: Cetin YILMAZ, Istanbul (TR); Sergen HAYDIN, Istanbul (TR)

(73) Assignee: BOGAZICI UNIVERSITESI, Istanbul (TR)

(21) Appl. No.: 18/854,576

(22) PCT Filed: Apr. 4, 2023
(86) PCT No.: PCT/TR2023/050316

§ 371 Date: Oct. 7, 2024

(30) Foreign Application Priority Data
Apr. 5, 2022 (TR) 2022/005338

(51) Int. Cl. F16F 15/04

(52) U.S. Cl. CPC F16F 15/046; F16F 2228/063; F16F 2228/066

(57) ABSTRACT

A variable stiffness system used as both a vibration isolation system and a vibration absorption system in systems ensures the protection of vibration-sensitive mechanical, optical, and electronic devices from vibration in industrial activities, and is also used as a variable stiffness spring or joint in robotic and biomedical fields.

### CROSS REFERENCE TO RELATED APPLICATIONS

This application is a national stage entry of International Application No. PCT/TR2023/050316, filed on Apr. 4, 2023, which is based upon and claims foreign priority to Turkey Patent Application No. 2022/005338, filed on Apr. 5, 2022, the entire contents of which are incorporated herein by reference.

### TECHNICAL FIELD

The invention relates to a variable stiffness system used as both a vibration isolation system and a vibration absorption system in systems that ensure the protection of vibration-sensitive mechanical, optical, and electronic devices from vibration in industrial activities, and also used as a variable stiffness spring or joint in robotic and biomedical fields.

### BACKGROUND

Today, variable stiffness systems can be used both as vibration isolation systems and vibration absorption systems. These variable stiffness systems can be used in industrial activities, in systems that ensure the protection of vibration-sensitive mechanical, optical, and electronic devices from vibration, in the field of robotics and biomedical systems. Variable stiffness systems are frequently encountered in the field of robotics, especially in robotic arms and in the field of biomedical prosthesis technology.

It is in the state of the art that variable stiffness systems are widely used in various fields. In variable stiffness systems, there are some unfavorable issues in the performance and excitation level of non-linear isolators. If the performance and excitation level of the isolator in question is small, the isolator and accordingly the stiffness system perform well. However, it is observed that the performance of the isolator deteriorates when the excitation level increases.

It is seen that the stiffness systems in the state of the art contain vibration-damping elements. It has been observed that these vibration dampers operate in a narrow range of 6.3 Hz to 7 Hz. The operation of vibration dampers in a narrow range restricts the use of stiffness systems.

This situation prevents said variable stiffness systems from being used in every embodiment.

In another known state of the art, there are variable stiffness systems used in various fields. In these variable stiffness systems, the response time of the stiffness change of the system is very long. Long response time in stiffness change leads to ineffectiveness in systems. In addition, there is a need for an external energy source from the outside in the stiffness systems in the present art.

There is an application numbered CN105179587 known in the literature. The invention provides a multiple-degree-of-freedom all-metal low-frequency passive vibration isolator with a large load. The vibration isolator consists of a load mounting table, horizontal vibration isolation press bars, a bottom bearing table, a vertical main bearing shaft, a vertical guide rail, an upper auxiliary platform, vertical support beams, negative stiffness adjusters, and roller bearings. The bottom plate is supported by the machine feet, and the like. Based on its Euler buckled beams and negative stiffness mechanism, it provides a three-directional nonlinear vibration isolator that is heavy in load and low in natural frequency, and its vibration isolation frequency can be achieved with a minimum of 1.5 Hz.

As a result, all the above-mentioned problems have made it imperative to innovate in the relevant technical field.

### SUMMARY

The present invention relates to a variable stiffness system with a very short response time, which can be adjusted with a very low force, with a wide operating frequency range, for eliminating the above-mentioned disadvantages and bringing new advantages to the related technical field.

An object of the invention is to provide a variable stiffness system whose stiffness can be changed and thus its natural frequency can be varied.

Another object of the invention is to provide a variable stiffness system that allows the stiffness of the system to be changed with a very low adjustment force thanks to the adjustment mechanism with quasi-zero-stiffness.

Another object of the invention is to provide a variable stiffness system that enables the response time of the stiffness change of the system to be fast thanks to the tensioning mechanism in the embodiment.

The present invention is a variable stiffness system used as both a vibration isolation system and a vibration absorption system in industrial activities, in systems that provide the protection of vibration-sensitive mechanical devices from vibration in robotic and biomedical areas in order to realize all the objects that will emerge from the abovementioned and the following detailed description. Accordingly, at least one body located in the negative stiffness section and extending in the direction of the y-axis, two opposing plates at both ends of said body and perpendicular to the body, at least one stud extending between the two plates, in the direction of the y-axis and parallel to the body, at least one upper beam and at least one bottom beam extending against each other, between said upper beam and the bottom beam and at equal distance from each other, and connected to the plates at both ends, at least one spring bottom plate located in the positive stiffness section and at the point where the central axis intersects the upper beam, one side of which is connected to the upper beam and the other side is connected to the compression spring, at least one compression spring located at the point where the central axis intersects said spring bottom plate and is connected to the spring bottom plate, at least one upper spring plate located above said compression spring and parallel to the spring bottom plate, the beam group, which is located opposite each other in the bottom section and provided by the group of multiple beams, at least one wire connected to the wire compression channel at the free end of said beam group and to the spring upper plate located on the compression spring, the positive stiffness section of said wire is provided through the negative stiffness section and the central axis of the bottom section and along the x-axis. Thus, it is to provide a variable stiffness system that aims to provide a stiffness change in the beam group and to make the response time of the variable stiffness system faster than the existing systems with close to zero effort and to provide a high amount of tension change in the wire connected to the beam group and thus a wide range of stiffness and natural frequency adjustment in the beam group.

A possible embodiment of the invention is characterized in that the stiffness of the positive stiffness section and the negative stiffness section are provided to be equal. Thus, it is to provide a variable stiffness system that is activated by applying a very small adjustment force thanks to the equal stiffnesses in the negative stiffness section and the positive stiffness section.

A possible embodiment of the invention is characterized in that at least one wire through a hole provided on said stud and through which the wire passes. Thus, it is to provide a variable stiffness system that is provided at maximum effectiveness by preventing the wire passing through the central axis from hitting the stud in cases such as using the system and making the stiffness adjustment on the system.

Another possible embodiment of the invention is characterized in that at least one nut positioned on the stud is used for buckling the upper beam and the bottom beam. Thus, it is to ensure that the upper beam and the bottom beam are fixed in order to maintain their current shape after buckling.

Another possible embodiment of the invention is characterized in that at least one bolt is used to buckle the upper beam and the bottom beam and is connected by passing through the hole. Thus, it is to ensure that the upper beam and the bottom beam are fixed in order to maintain their current shape after buckling.

Another possible embodiment of the invention is characterized in that the centering element on the spring bottom plate and the compression spring are connected. Thus, it helps the compression spring remain in an upright position while under force.

Another possible embodiment of the invention is characterized in that there is at least one wire holder bottom part located in the positive stiffness section and one end of the wire is connected and at least one wire holder upper part is connected to said wire holder bottom part. Thus, it helps to make the adjustment force with an effort close to zero.

Another possible embodiment of the invention is characterized in that the pin is connected to a pin slot in the spring upper plate through the spring upper plate pin hole. Thus, the wire holder provides a system to prevent the wire holder from rotating the bottom part while the upper part is rotating.

### BRIEF DESCRIPTION OF THE DRAWINGS

FIG. 1 shows a representative overview of a variable stiffness system of the invention.

FIG. 2 shows a representative bottom section of a system of the invention with variable stiffness and a view of the elements of the bottom section.

FIG. 3 shows a view of a representative beam group of a variable stiffness system of the invention laterally buckling towards two different sides.

FIG. 4 shows a representative view of a variable stiffness system of the invention in which the natural frequency and stiffness are at maximum.

FIG. 5 shows a representative view of a variable stiffness system of the invention in which the natural frequency and stiffness are lower than their maximum levels.

FIG. 6 shows a connected view of a representative negative stiffness section and positive stiffness section of a variable stiffness system of the invention.

FIG. 7 shows a representative view of a variable stiffness system of the invention in which the negative stiffness section is buckled with the help of a compression stud.

FIG. 8 shows a general view of the spring in a representative upper section of a variable stiffness system of the invention.

FIG. 9 shows an exploded view of the elements in a representative upper section of a variable stiffness system of the invention.

FIG. 10 shows a representative view of a variable stiffness system of the invention in which a stud, wire-through hole, and wire are shown.

FIG. 11 shows a graph of the change in the natural frequency of the free end of a representative beam group of a variable stiffness system of the invention according to the wire tension.

FIG. 12 shows a representative force-displacement graph of a variable stiffness system subject to the invention.

### REFERENCE NUMBERS GIVEN IN THE FIGURES

10 Positive Stiffness Section
   11 Spring Upper Plate
   12 Spring Bottom Plate
   13 Wire Holder Upper Part
   14 Wire Holder Bottom Part
   15 Compression Spring
   16 Spring Housing
   17 Pin Hole
   18 Pin Slot
   19 Spring Centering Element
20 Negative Stiffness Section
   21 Upper Beam
   22 Bottom Beam
   23 Wire Through Hole
   24 Body
   25 Plate
   26 Nut
   27 Bolt
   28 Stud
   29 Bolt Adjustment Groove
30 Bottom Section
   31 Beam
   32 Beam Group
   33 Free End
   34 Wire Compression Channel
40 Wire
50 Pin
X X Axis
Y Y Axis
Z Z Axis
Central Axis
D Displacement
F Adjustment Force
W Natural Frequency
T Wire Tension
B Buckling Force

### DETAILED DESCRIPTION OF THE EMBODIMENTS

In this detailed description, the subject matter of the invention is explained only by means of examples that will not have any limiting effect for a better understanding of the subject matter.

The invention relates to a variable stiffness system used as both a vibration isolation system and a vibration absorption system in industrial activities, in systems that provide the protection of vibration-sensitive mechanical devices from vibration, in robotics and biomedical fields. A variable stiffness system of the invention basically includes the positive stiffness section (10), the negative stiffness section (20), and the bottom section (30) containing the axially loaded beams. A structure is provided so that the stiffnesses of said positive stiffness section (10) and said negative stiffness section (20) are equal.

There is at least one body (24) located in the negative stiffness section (20) and extending in the direction of the y-axis (Y), two opposing plates (25) located at both ends of said body (24) and perpendicular to the body (24). There is at least one upper beam (21) and at least one bottom beam (22) extending in the direction of the y-axis (Y) and parallel to the body (24) between the two plates (25). There is provided at least one stud (28) extending along the y-axis (Y) and connected at both ends to the plates (25) between the upper beam (21) and the bottom beam (22) and at an equal distance to each of them.

There is at least one spring bottom plate (12) connected to the upper beam (21) at the point where the positive stiffness section (10) and the central axis (O) intersect the upper beam (21), and at least one compression spring (15) located at the point where the central axis (O) intersects the said spring bottom plate (12) and is connected to the spring bottom plate (12). At least one upper spring plate (11) is provided on the compression spring (15) and parallel to the spring bottom plate (12).

The beam group (32) is located in the bottom section (30) and is provided by the combination of many beams (31). At least one wire (40) is provided in contact with the wire compression channel (34), one end of which is located at the free end (33) of the beam group (32), and the other end of which is located on the spring upper plate (11), which is located on the compression spring (15).

The wire (40) is provided so as to pass through the positive stiffness section (10), the negative stiffness section (20), and the central axis (O) of the bottom section (30) and along the x-axis (X).

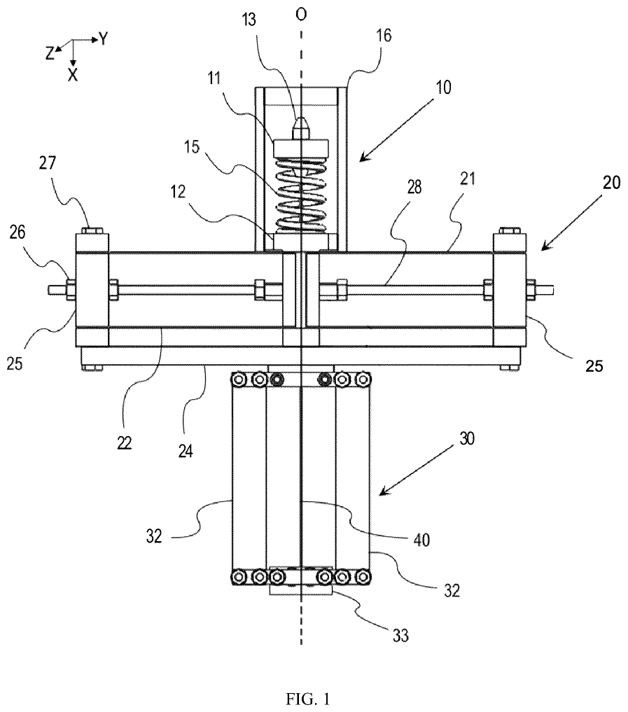

The general structure of the variable stiffness system is shown in FIG. 1. In the bottom section (30) there is the beam group (32), which is reciprocally located with each other and provided by the group of a plurality of beams (31). The beam group (32) assumes an axial load such that it is on the central axis (O). A wire (40) passing through the central axis (O) of the embodiment is used to transmit the axial load to the beam group (32). One end of the wire (40) is connected to the wire compression channel (34) located at the free end (33) of the axially loaded beam group (32). Thus, the force on the wire (40) can be transmitted equally to all the beams (31) forming the beam group (32). The other end of the wire (40) is connected to the spring upper plate (11) located on the helical compression spring (15).

There is also at least one spring bottom plate (12) connected to the upper beam (21) at the point where the central axis (O) intersects the upper beam (21). When the spring bottom plate (12) between the compression spring (15) and the upper beam (21) rises, the compression spring (15) pushes the spring upper plate (11) and as a result, the wire (40) is tense. If the wire tension (T) of the wire (40) element exceeds the total buckling force (B) of the beams (31) in the beam group (32), the beams (31) are buckled to one side as seen in FIG. 3.

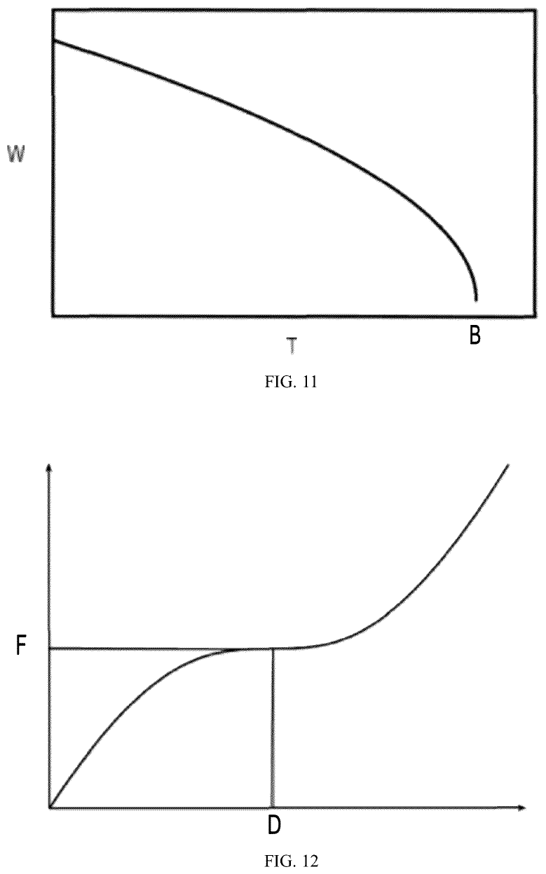

If the tensile force in the wire (40) approaches the buckling force (B) but does not exceed this value, the stiffness of the beams (31) in the beam group (32) in the lateral direction decreases. As a result, the natural frequency (W) of the free end (33) of the beam group (32) decreases as seen in the graph in FIG. 11.

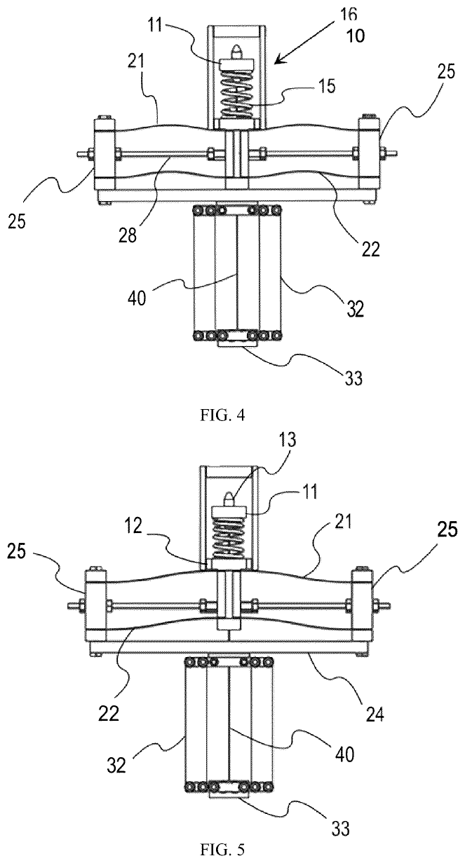

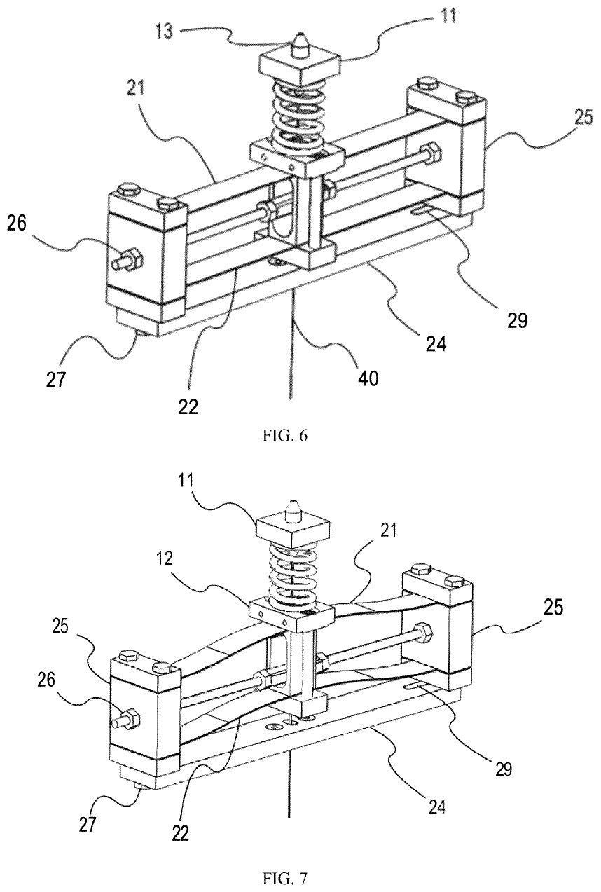

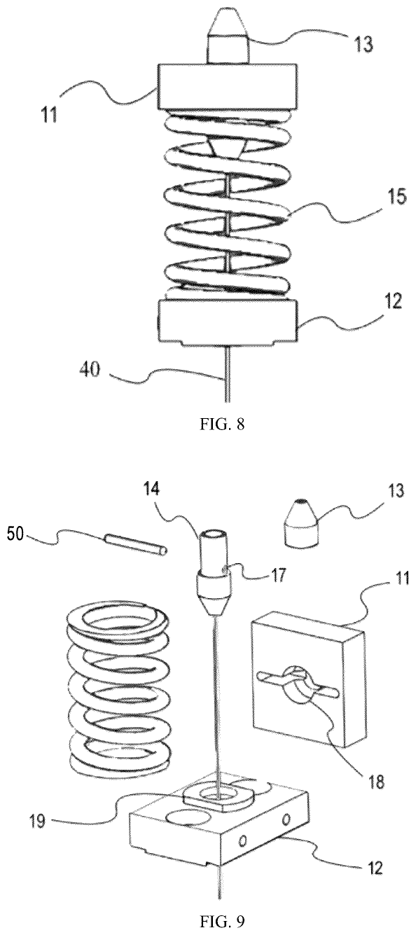

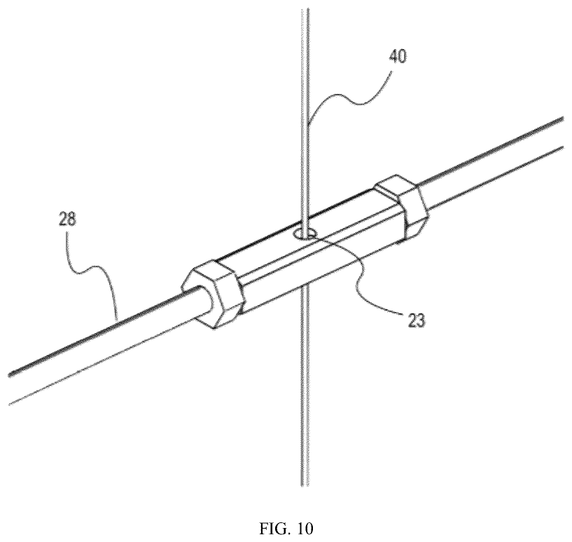

The position of the spring bottom plate (12) on the x-axis (X) may be changed by moving the spring housing (16) in the opposite direction of the x-axis (X) and the direction of the x-axis (X). As a result, both the stiffness of the beams (31) in the beam group (32) and the natural frequency (W) of the free end (33) of the beam group (32) can be adjusted by increasing or decreasing the tension of the wire (40). As can be seen in FIG. 4, when the spring bottom plate (3) is in the lowest position, the stiffness and natural frequency (W) of the free end (33) of the beam group (32) in the direction of the z-axis (Z) is at the highest level. If the spring bottom plate (12) moves in the opposite direction of the x-axis (X), the stiffness and natural frequency (W) of the free end (33) of the beam group (32) in the direction of the z-axis (Z) decreases as shown in FIG. 5.

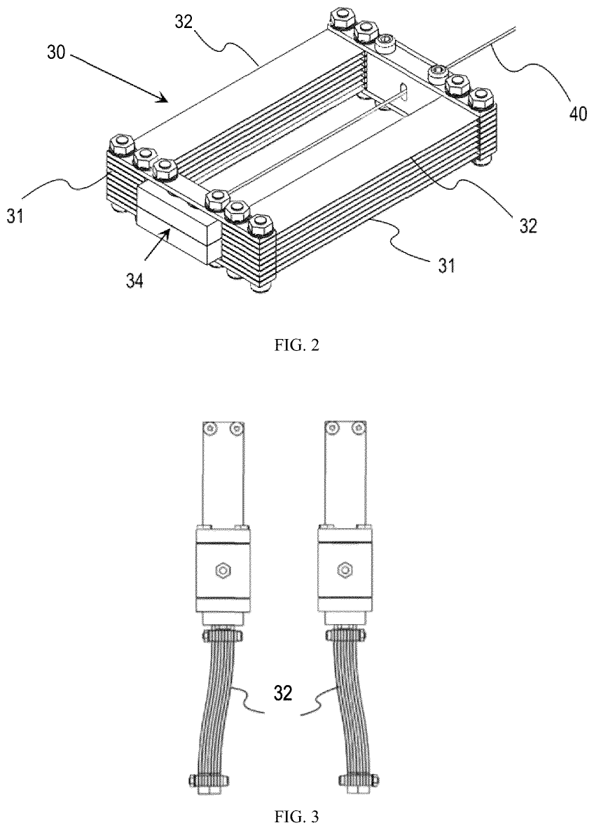

FIG. 2 shows the elements forming the bottom section (30) of the variable stiffness system. The number of beams (31) in the beam group (32) in FIG. 2 can be increased or decreased according to the amount of stiffness desired and the mass desired to be carried. However, in order for the variable stiffness system to work, it is necessary to have at least two beams (31) in two beam groups (32) that are placed on opposite sides. In addition, in order for the system to work in a balanced way, the number of beams (31) in both beam groups (32) is equal and the dimensions of the beams (31) must be the same.

The negative stiffness section (20) shown in FIG. 1 is used to minimize the adjustment force (F) required to change the stiffness of the beams (31) in the beam group (32) and thus the natural frequency (W) of the free end (33) of the beam group (32). The adjustment force (F) is a force applied to the spring housing (16) in the direction of the x-axis (X) or the opposite direction of the x-axis (X). When the positive stiffness of the compression spring (15) in the positive stiffness section (10) and the negative stiffness of the negative stiffness section (20) are equal, a system with quasi-zero-stiffness emerges. The resulting adjustment force-displacement graph is shown in FIG. 12. When the variable stiffness system is in the equilibrium position, the slope of the adjustment force-displacement graph around the adjustment force (F) corresponding to the displacement (D) value is close to zero. Therefore, it is observed that the adjustment force (F) does not change while the displacement (D) changes around the equilibrium position.

When the adjustment force (F) is set close to zero and the spring housing (16) moves in the direction of the x-axis (X), the amount of tension on the wire (40) varies significantly. However, an effort close to zero is spent on this change. The positive stiffness section (10) and the negative stiffness section (20) shown in FIG. 1 are used together in order to adjust the adjustment force (F) to be close to zero.

In FIG. 9, the elements in the positive stiffness section (10) are shown in detail. There are threads on the wire holder bottom part (14). The inner surface of the wire holder upper part (13) also has threads. By rotating the wire holder upper part (13), its level in the direction of the x-axis (X) changes and the adjustment force (F) can be brought to a value close to zero. The wire holder bottom part (14) should not rotate while the wire holder upper part (13) rotates. The non-rotation of the wire holder bottom part (14) is provided by a pin (50) passing through the pin hole (17) on the wire holder upper part (13). The pin (50) fits into a pin slot (18) located in the spring upper plate (11).

When the tension of the wire (40) used in the variable stiffness system changes, the compression force on the compression spring (15) also changes. In order for the compression spring (15) to remain in an upright position while under force, the compression spring (15) and the wire (40) must be located concentrically, that is, on the central axis (O). The positioning of the compression spring (15) and the wire (40) so that they are on the central axis (O) and concentric with each other is provided by the spring centering element (19). FIG. 9 shows the spring centering element (19) used to center the compression spring (15) and to ensure that the compression spring (15) is located perpendicularly even under force.

The maximum force applied to the beams (31) in the beam group (32) should not exceed the critical buckling force (B) of said beams (31). In this way, the natural frequency (W) of the free end (33) of the beam group (32) can be adjusted stably. If the critical buckling force (B) of the beams (31) in the beam group (32) is exceeded, the free end (33) of the beam group (32) leans to one side as shown in FIG. 3. In order to adjust the maximum value of the tensile force, it is necessary to adjust the buckling amount of the upper beam (21) and the bottom beam (22) located in the negative stiffness section (20). While an upper beam (21) and a bottom beam (22) are visible in FIG. 1, in another embodiment of the system, multiple upper beams (21) and multiple bottom beams (22) may be positioned parallel to each other.

FIG. 7 shows the appearance that the upper beam (21) and the bottom beam (22) in the negative stiffness system (20) are twisted with the help of the stud (28). In order to buckle the upper beam (21) and the bottom beam (22), the nuts (26) on the stud (28) element need to be tightened. During the buckling of the upper beam (21) and the bottom beam (22), the bolts (27) passing through the bolt adjustment grooves (29) on the body (24) in the negative stiffness section (20) are loose and both ends of the upper beam (21) and the bottom beam (22) are attached to the opposing plates (25). After adjusting the buckling amount for the upper beam (21) and the bottom beam (22), the nuts (26) and bolts (27) are tightened.

While the upper beam (21) and the bottom beam (22) in the negative stiffness section (20) exhibit negative stiffness behavior in the x-axis (X) direction, it is ensured that the wire (40) passes through the middle of the upper beam (21) and the bottom beam (22), that is, the central axis (O), so that it does not bend in the y-axis (Y) or z-axis (Z). In addition, there is a wire through hole (23) on the stud (28) so that the wire (40) passing through the center of the upper beam (21) and the bottom beam (22), that is, over the central axis (O), does not hit the stud (28).

The protection scope of the invention is specified in the appended claims and cannot be strictly limited to those explained in this detailed description for illustrative purposes. It is evident that a person skilled in the art may exhibit similar embodiments in light of the foregoing without departing from the main theme of the invention.

1. A variable stiffness system used as both a vibration isolation system and a vibration absorption system in industrial activities, in systems that provide the protection of vibration-sensitive mechanical devices from vibration, in robotics and biomedical fields, comprising:
at least one body located in a negative stiffness section and extending in a direction of a y-axis,
two opposing plates positioned at both ends of the at least one body and perpendicular to the at least one body,
at least one upper beam and at least one bottom beam extending in the direction of the y-axis and parallel to the at least one body between the two plates,
at least one stud extending along the y-axis between the upper beam and the bottom beam and equidistant from each other and connected at both ends to the plates, at least one spring bottom plate in a positive stiffness section and at the point where a central axis intersects the upper beam, one side being connected to the upper beam and the other side to the compression spring,
at least one compression spring positioned at the point where the central axis intersects the spring bottom plate and is connected to the spring bottom plate,
at least one spring upper plate located above the spring and parallel to the spring bottom plate,
a beam group, which is mutually present in a bottom section, and which is provided by a combination of multiple beams,
at least one wire, one end of which is connected to a wire compression channel located at a free end of the beam group and the other end of which is connected to the at least one spring upper plate located on the compression spring,
ensuring that the wire passes through the positive stiffness section, the negative stiffness section, and the central axis of the bottom section and along a x-axis.

2. The variable stiffness system according to claim 1, wherein a stiffness of the positive stiffness section and the negative stiffness section are equalized.

3. The variable stiffness system according to claim 1, further comprising at least one wire through hole provided on the at least one stud and through which the wire passes.

4. The variable stiffness system according to claim 1, further comprising at least one nut positioned on the at least one stud, used in a buckling of the upper beam and the bottom beam.

5. The variable stiffness system according to claim 1, further comprising at least one bolt used in the buckling of the upper beam and the bottom beam and connected by passing through a bolt adjustment groove.

6. The variable stiffness system according to claim 1, further comprising a spring-centering element located on the spring bottom plate and to which the compression spring is connected.

7. The variable stiffness system according to claim 1, further comprising at least one wire holder bottom part located in the positive stiffness section and connected to one end of the wire and at least one wire holder upper part connected to the at least one wire holder bottom part.

8. The variable stiffness system according to claim 1, further comprising a pin connected to a pin slot in the at least one spring upper plate by passing through the pin hole.
